(19) United States
(12) Patent Application Publication
(10) Pub. No.: US 2007/0127570 A1
(43) Pub. Date: Jun. 7, 2007

(54) Image processor and image processing method

(76) Inventor: Tatsuro Juri, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/605,411

(22) Filed: Nov. 29, 2006

(30) Foreign Application Priority Data
Dec. 1, 2005 (JP) 2005-348509

(51) Int. Cl. H04N 7/12

(52) U.S. Cl. 375/240.12; 375/240.26

(57) ABSTRACT

An image processor, which requires a transfer rate lower than the conventional rate, for transmitting pixel data between a DDR-DRAM and a memory, and is configured of: a decoded chrominance pixel output unit which writes pixel data into a DDR-DRAM per p×q pixel unit or per p×q pixel units, each pixel unit being made up of p lines of pixels aligned in a vertical direction and q rows of pixels aligned in a horizontal direction; and a reference chrominance pixel input unit which reads out the pixel data of the pixels from the DDR-DRAM per p×q pixel unit or p×q pixel units, in which the decoded chrominance pixel output unit has an interleaving unit that interleaves q rows of p×q pixels to be written into the DDR-DRAM, so as to generate a pixel data sequence in which the pixel data of the pixels located in q rows is multiplexed and placed in a line.

### BACKGROUND OF THE INVENTION

(1) Field of the Invention

The present invention relates to an image processor which performs image processing on pictures held in a memory, and, in particular, to an improved technology in data transfer between the image processor and the memory.

(2) Description of the Related Art

With the advancement of High Definition (HD) video in digital video products, image coding is used for reducing a data rate in recording or transmission of data. A method of greatly decreasing the data amount by estimating, on a block basis, a motion between frames and fields, as defined by MPEG-2 and H.264, and transferring the resulting difference information is used (see Japanese Laid-Open Patent Application No. 01-168165).

FIG. 11 is a block diagram showing a conventional image coding apparatus 100. Note that a Double Data Rate DRAM (DDR-DRAM) 101 is a DRAM that is externally attached to the image coding apparatus 100.

The image coding apparatus 100 is an apparatus which codes moving pictures through compression, and is configured of a memory control unit 102, a coding pixel input unit 103, a reference luminance pixel input unit 104, a motion estimation internal memory 105, a motion estimation unit 106, a reference chrominance pixel input unit 107, a luminance motion compensation coding/decoding unit 108, a chrominance motion compensation coding/decoding unit 109, a decoded luminance pixel output unit 110, a decoded chrominance pixel output unit 111, a variable length coding unit 112, and a coded output unit 113.

The memory control unit 102 is a circuit for controlling input and output of the data between the DDR-DRAM 101 and the image coding apparatus 100. The coded pixel input unit 103 is a circuit for reading out the pixel data of the pixel to be coded from the DDR-DRAM 101. The reference luminance pixel input unit 104 is a circuit for reading out the pixel data of the reference luminance pixel to be used for motion estimation from the DDR-DRAM 101. The motion estimation internal memory 105 is a memory which stores the pixel data of the reference luminance pixel which is read-out by the reference luminance pixel input unit 104. The motion estimation unit 106 is a circuit which estimates an amount of a motion between fields or frames per predetermined block unit. The reference chrominance pixel input unit 107 is a circuit for reading out the pixel data of the reference chrominance pixel from the DDR-DRAM 101. The luminance motion compensation coding/decoding unit 108 is a circuit for performing motion compensation, coding and decoding on luminance pixels. The decoded luminance pixel output unit 110 is a circuit for outputting the pixel data of the decoded luminance pixels to the DDR-DRAM, 101. The decoded chrominance pixel output unit 111 is a circuit for outputting the pixel data of the decoded chrominance pixels to the DDR-DRAM 101. The variable length coding unit 112 is a circuit for performing variable length coding on the pixel data of the coded luminance pixels and chrominance pixels. The coded output unit 113 is a circuit for outputting a coded word obtained by the variable length coding unit 112 to the DDR-DRAM 101.

The operation of coding the pixel data made up of a luminance pixel and blue and red chrominance pixels will be described with reference to FIG. 11. The pixel data of the luminance pixel, the blue chrominance pixel, and the red chrominance pixel, which are stored in the DDR-DRAM 101 and are to be coded, is read out by the coded pixel input unit 103 via the memory control unit 102. At the same time, the pixel data of the luminance pixel of different fields or frames which are coded, decoded and then stored in the DDR-DRAM 101 is read out as the pixel data of the reference luminance pixel by the reference luminance pixel input unit 104 via the memory control unit 102, and then stored in the motion estimation internal memory 105.

Then, the motion estimation unit 106 estimates, per predetermined block unit, a motion between the pixel data of the reference luminance pixel stored in the motion estimation internal memory 105 and the pixel data of the of the luminance pixel which is to be coded and is read out by the coded pixel input unit 103. Based on the amount of motion (motion vector) thus obtained, the reference chrominance pixel input unit 107 reads out, via the memory control unit 102, the pixel data of the blue and red chrominance pixels of different fields or frames which are coded, decoded and then stored in the DDR-DRAM 101, as the pixel data of the reference chrominance pixel for motion compensation. Then, a difference value between the pixel data of the chrominance pixel to be coded based on the motion vector and the pixel data of the reference chrominance pixel is calculated by the chrominance motion compensation coding/decoding unit 109, and then, the difference value is coded and decoded.

The pixel data of the decoded luminance pixel and the chrominance pixel which are obtained through the above-mentioned processing is outputted by the decoded luminance pixel output unit 110 and the decoded chrominance pixel output unit 111 via the memory control unit 102 to the DDR-DRAM 101. Here, the pixel data of the decoded luminance pixel and chrominance pixel outputted by the DDR-DRAM 101 is used as the pixel data of reference pixels in the coding thereafter. At the same time, the pixel data of the luminance pixel and chrominance pixel which are coded by the luminance motion compensation coding/decoding unit 108 and the chrominance motion compensation coding/decoding unit 109 is variable-length coded by the variable length coding unit 112 and then outputted to the DDR-DRAM 101 via the memory control unit 102.

Thus, according to the conventional image coding apparatus, compression and coding of images is performed through the repetition of input and output of the pixel data to and from the external DDR-DRAM 101.

However, with the conventional image coding apparatus, a problem is that an extremely high transfer rate is required for reading out the pixel data of reference chrominance pixel from a DDR-DRAM. Such a problem is particularly serious in the case of compressing/coding images with high resolution such as HD video or the like.

The following describes the processing of reading out the pixel data of reference chrominance pixel from the DDR-DRAM 101, carried out by the conventional image coding apparatus 100. Here, the DDR-DRAM 101 is assumed to be a high-speed DDR2 memory, taking HD compatibility into consideration. In the DDR2 memory, one memory is divided into four banks, and a unit to access one bank is 8 cycles (=4 clocks). Therefore, in the case where a word is 16 bits, in general, it is possible to access per 16 bytes.

FIG. 12 shows a reading out position on the DDR-DRAM 101 for reading out the pixel data of reference chrominance pixel from the pixel data of decoded chrominance pixel placed in the DDR-DRAM 101, according to the motion vector obtained by the motion estimation unit 106. A motion vector may indicate an arbitrary position on the screen, so that there is a necessity to read out the pixel data of the corresponding reference chrominance pixel from the arbitrary position on the memory. In the example shown in FIG. 12, it is assumed that the pixel data of the reference pixel which corresponds to the blue chrominance pixel of horizontal four pixels and vertical eight lines is read out. In such a case, considering the filtering process in the motion compensation, it is necessary to read out the pixel data of the reference chrominance pixel of horizontal five pixels and vertical nine lines. As shown in FIG. 12, the horizontal five pixels in the arbitrary position on the DDR-DRAM 101 is located across two 16 bytes a line (or two banks) at maximum. Therefore, the maximum amount of actual reading is horizontal 16×2 bytes and vertical nine lines. This causes the need to read out a huge amount of pixel data besides the pixel data of reference pixel that is actually needed.

Such a process of reading out the reference chrominance pixel shall be performed for a red reference chrominance pixel in addition to a blue reference chrominance pixel; therefore, it is a major problem in the implementation in terms of memory transfer rate.

FIG. 13 shows a timing at which the part to be read out shown in FIG. 12 is actually read out from the DDR-DRAM 101. The first row shows a cycle, and one clock is equivalent of two cycles in the DDR2 memory. In the DDR2 memory, intervals of more than a predetermined period of time are required for the reading of the same bank. In this example, in order to read out again the same bank, a time required for reading out all the other banks one time for each, that is, an interval of twenty-four cycles (eight cycles×three banks) is necessary. Therefore, it is possible to sequentially read out the data in banks 0 and 1 per cycle. For the reading of bank 1 and then bank 0, an intermission of 16 cycles (cycle equivalent to banks 2 and 3) is necessary. As described above, reading the pixel data of reference chrominance pixel requires a great amount of redundancy in terms of memory reading unit and reading cycle.

FIG. 14 is a diagram showing a concrete example of a speed at which the conventional image coding apparatus 100 accesses the DDR-DRAM 101. The diagram shows a necessary data transfer rate between the DDR-DRAM 101 and the image coding apparatus 100 shown in FIG. 11 in the case where the image coding apparatus 100 codes HD video of horizontal 1920 pixels, vertical 1088 lines, and 30 frames/second. In the left column, “coded pixel input”, “reference luminance pixel input”, “reference chrominance pixel input”, “decoded luminance pixel output”, “decoded chrominance pixel output”, “compressed data and others” and “total” corresponds to a transfer (read/write) of the pixel data between the DDR-DRAM 101 and the coded pixel input unit 103, the reference luminance pixel input unit 104, the reference chrominance pixel input unit 107, the decoded luminance pixel output unit 110, the decoded chrominance pixel output unit 111, the coded output unit 113 and the image coding apparatus 100, respectively.

As can be seen from the “actual transfer rate” and “total” shown in FIG. 14, in the case of a general memory placement for the pixel data of reference pixel, as shown in FIG. 12, “actual transfer rate” is as high as 2816 MB/s in total, and it requires as much as 1128 MB/s particularly for “reference chrominance pixel input”.

Note that the followings are significations of respective values in the row “reference chrominance pixel input” in FIG. 14. That is to say that “necessary transfer amount per MB (macroblock)” is 5 (the number of horizontal pixels)×9 (the number of lines)×2 (two chrominance of blue and red)×2 (the number of data per chrominance)×2 (two for forward reference and backward reference), while “actual amount of transfer per MB” is 32 (the number of bytes for two banks)×9 (the number of lines)×2 (chrominance of blue and red)×2 ((the number of data per chrominance)×2 (two for forward reference and backward reference). When the “actual transfer amount per MB” is converted into a transfer rate of the HD video, “transfer rate” is 564 MB/s. The “memory access overhead” is “x2” based on the condition (two banks per four banks) shown in FIG. 13. Consequently, “actual transfer rate” is 1128 MB/s because of 564 MB/s (transfer rate)×2 (memory access overhead).

In this way, with the conventional technology, a total value of “actual transfer rate” amounts to 2816 MB/s, which necessitates an operation of the DDR2 memory at 700 MHz or greater. Therefore, such an operation cannot be realized with a memory presently available. Even though the operation is realizable with an existing memory, a costly image coding apparatus or an image coding apparatus requiring high consumption power due to high clock rate shall be required.

### SUMMARY OF THE INVENTION

The present invention is conceived in view of the above-mentioned circumstances and an object of the present invention is to provide an image processor which operates at a transfer rate lower than the conventional transfer rate, for exchanging the pixel data with a memory such as a DDR-DRAM.

In order to achieve the above-mentioned object, the image processor according to the present invention is an image processor which is connected to a memory and performs image processing on a picture held in the memory. The processor is comprised of: a pixel output unit operable to write pixel data of pixels into the memory per p×q pixel unit or p×q pixel units, where p is a natural number of 2 or greater and q is a natural number, the pixel unit being made up of p lines of pixels aligned in a vertical direction and q rows of pixels aligned in a horizontal direction; and a pixel input unit operable to read the pixel data per p×q pixel unit or p×q pixel units from the memory, in which the pixel output unit includes an interleaving unit operable to interleave q rows of p×q pixels to be written into the memory, so as to generate a pixel data sequence in which the pixel data of the pixels located in q rows are multiplexed and placed on one line. Thus, the pixel data of plural lines is interleaved, and written into a memory as one pixel data sequence, which increases the amount of data transfer per access in the DDR-DRAM or reduces memory access overhead. Therefore the transfer rate of pixel data between a memory such as a DDR-DRAM and the image processor is lowered compared to the conventional case.

The picture includes first and second chrominance images, and the interleaving unit is operable to interleave q rows of p×q pixels of the first and second chrominance images and the pixel data of the first and second chrominance images so as to generate a pixel data sequence in which the pixel data of the first chrominance image and the pixel data of the second chrominance image are alternately placed to make a line, and the pixel data, of the respective chrominance images, of the pixels located in q rows are multiplexed and placed on one line. Thus, chrominance interleaving is simultaneously performed in addition to line interleaving, and the pixel data of the chrominance pixel is effectively stored into the DDR-DRAM. Thus, the transfer rate of pixel data between a memory such as a DDR-DRAM and the image processor is greatly reduced compared to the conventional transfer rate.

Note that p is a value of power-of-two. For example, when p is 4, 8, 16 or the like, the interleaved pixel data sequence equals to an access alignment (e.g. 16 bytes alignment) of the DDR-DRAM, or is integral multiple or parts of integral number. This heightens the possibility at which the pixel data sequence is effectively stored in the banks of the DDR-DRAM, and may decrease the data transfer rate.

In order to achieve the above-mentioned object, the image processor of the present invention is an image processor which is connected to a memory and performs image processing on a picture held in the memory. The processor is comprised of: a pixel output unit operable to write pixel data of pixels into the memory per p×q pixel unit or p×q pixel units, where p is a natural number of 2 or greater and q is a natural number, the pixel unit being made up of p lines of pixels aligned in a vertical direction and q rows of pixels aligned in a horizontal direction; and a pixel input unit operable to read the pixel data from the memory per p×q pixel unit or p×q pixel units, in which the picture includes first and second chrominance images, and the pixel output unit includes an interleaving unit operable to interleave the pixel data of p×q pixels of the first and second chrominance images to be written in the memory, so as to generate a pixel data sequence in which the pixel data of the first chrominance image and the pixel data of the second chrominance image are alternately placed to make a line. Thus, the pixel data of the chrominance pixel is interleaved and then effectively stored into the DDR-DRAM. Therefore, the transfer rate of pixel data between a memory such as a DDR-DRAM and the image processor becomes lower than the conventional transfer rate.

Note that the present invention can be realized not only as such an image processor, but also as a one-chip semiconductor integrated circuit such as an LSI, or as an image coding apparatus equipped with video compression and coding functions, or as an image decoding apparatus equipped with the functions to expand/decode compressed video, or as an image processing method that includes the components of the image processor as steps, or as a program that causes a computer to execute the steps included in the image processing method, or as a computer-readable storage medium such as a CD-ROM in which the program is stored.

The present invention requires an extremely low transfer rate for pixel data between a memory such as a DDR-DRAM and the image processor. Therefore, it is possible to perform image processing using a memory with a low access speed, which realizes an image processor that performs the same image processing as the conventional one with low cost and low power consumption.

The present invention particularly achieves low cost and low power consumption in digital video products which performs recording and reproduction of images with high resolution such as HD video; therefore its practical value is extremely high.

For further information about technical background to this application, the disclosure of Japanese Patent Application No. 2005-348509 filed on Dec. 1, 2005 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a functional block diagram showing the configuration of the image coding apparatus according to the embodiment of the present invention;

FIG. 2 is a diagram showing a sequence of pixel data in the case of line interleaving;

FIG. 3 is a diagram showing a memory placement for pixel data of chrominance-interleaved chrominance pixel;

FIG. 4 is a diagram showing a timing of data transfer in the memory displacement shown in FIG. 3;

FIG. 5 is a diagram showing a memory placement for pixel data of chrominance/line interleaved chrominance pixel;

FIG. 6 is a diagram showing a timing of data transfer in the memory placement shown in FIG. 5;

FIG. 7 is a diagram showing a concrete example of an access speed at which the image coding apparatus that performs chrominance/line interleaving accesses a DDR-DRAM;

FIG. 8 is a functional block diagram showing the configuration of the image decoding apparatus according to the embodiment of the preset invention;

FIG. 9 is a block diagram showing the configuration of the image processor according to the present invention;

FIG. 10 is a diagram showing another example of line interleaving;

FIG. 11 is a block diagram showing the configuration of the conventional image coding apparatus;

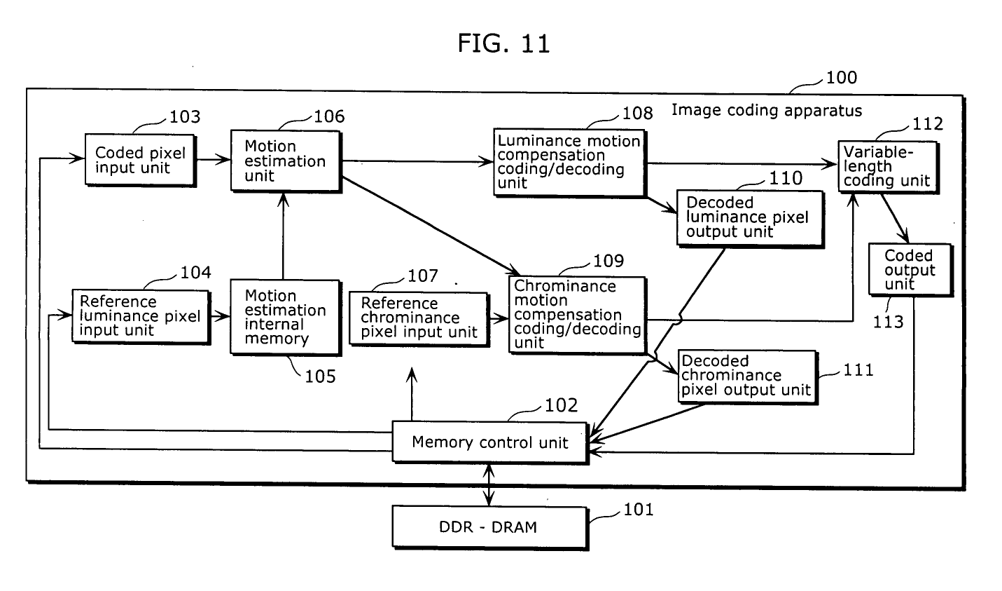

FIG. 12 is a diagram showing a read-out position for reading out pixel data of reference chrominance pixel from a DDR-DRAM according to the conventional technology;

FIG. 13 is a diagram showing timing for reading out a part to be read out shown in FIG. 12 according to the conventional technology; and

FIG. 14 is a diagram showing a concrete example of an access speed at which the conventional image coding apparatus accesses a DDR-DRAM.

### DESCRIPTION OF THE PREFERRED EMBODIMENT(S)

The following describes in detail the embodiment of the present invention with reference to the diagrams.

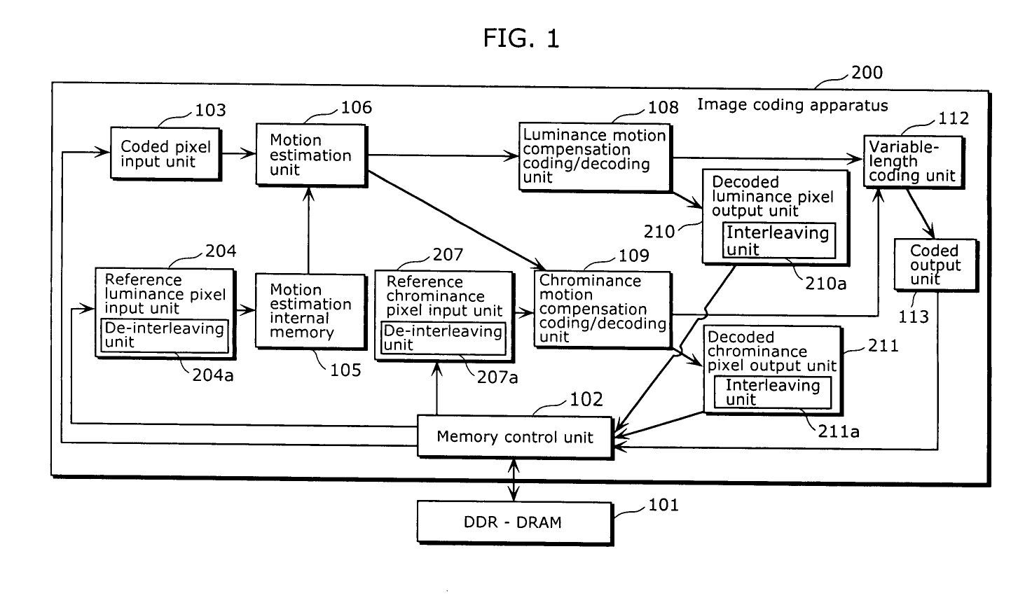

FIG. 1 is a functional block diagram showing a configuration of an image coding apparatus 200 according to the embodiment. Note that the DDR-DRAM 101 in the diagram is a DRAM externally equipped to the image coding apparatus 200.

The image coding apparatus 200 is equipped with a function to interleave the pixel data of decoded luminance pixel and chrominance pixel, and store the interleaved pixel data into a DDR-DRAM, and is configured of the memory control unit 102, the coded pixel input unit 103, a reference luminance pixel input unit 204, the motion estimation internal memory 105, the motion estimation unit 106, a reference chrominance pixel input unit 207, the luminance motion compensation coding/decoding unit 108, the chrominance motion compensation coding/decoding unit 109, a decoded luminance pixel output unit 210, a decoded chrominance pixel output unit 211, the variable length coding unit 112 and the coded output unit 113.

The reference luminance pixel input unit 104, the reference chrominance pixel input unit 107, the decoded luminance pixel output unit 110 and the decoded chrominance pixel output unit 111 among the components of the conventional image coding apparatus 100 respectively correspond to the reference luminance pixel input unit 204, the reference chrominance pixel input unit 207, the decoded luminance pixel output unit 210 and the decoded chrominance pixel output unit 211 of the image coding apparatus 200. Hereafter, the same referential marks are provided for the same components as the components of the conventional image coding apparatus 100, and the descriptions are omitted.

The decoded luminance pixel output unit 210 is a circuit which stores the decoded luminance pixels obtained by the luminance motion compensation coding/decoding unit 108 after having interleaved the pixels of plural lines, and has an interleaving unit 210a.

The interleaving unit 210a is a circuit which interleaves for the purpose described above. When writing pixel data into the DDR-DRAM 101 per p×q pixel unit or per p×q pixel units (p is a natural number of 2 or greater and q is a natural number), each pixel unit being made up of p lines of pixels aligned in a vertical direction and q rows of pixels aligned in a horizontal direction, the interleaving unit 210a interleaves q rows of p×q pixels so as to generate a pixel data sequence (access block) in which the pixel data of the pixels located in q rows is multiplexed and placed on one line. For example, when writing the pixel data per macroblock of 16 lines×16 pixels into the DDR-DRAM 101, the interleaving unit 210a interleaves the pixel data of 16 lines×16 pixels per four lines (4 lines×16 pixels) so as to generate a pixel data sequence. More precisely, assuming that pixel data in line i, row j is expressed as Y (i,j), the interleaving unit 210a generates a pixel data sequence in which the pixel data of Y (1,1) Y (2,1), Y (3,1), Y (4,1), Y (1,2), Y (2,2), Y(3,2), Y(4,2), Y (1,3), . . . , Y (4,16) is placed in this order. The decoded luminance pixel output unit 210 writes the interleaved pixel data generated by the interleaving unit 210a into the DDR-DRAM 101.

The decoded chrominance pixel output unit 211 is a circuit for interleaving the pixel data of the decoded chrominance pixel obtained by the chrominance motion compensation coding/decoding unit 109 in one of the following manners: interleaving the pixel data of chrominance (blue and red) pixels of two types (hereinafter referred to as “chrominance interleaving”); interleaving the pixel data of the pixels of plural lines in addition to the chrominance interleaving (such an interleaving with respect to color and line of the chrominance pixel is hereinafter referred to as “chrominance/line interleaving”), and storing the interleaved pixel data into the DDR-DRAM 101 via the memory control unit 102. Such a decoded chrominance pixel output unit 211 has an interleaving unit 211a.

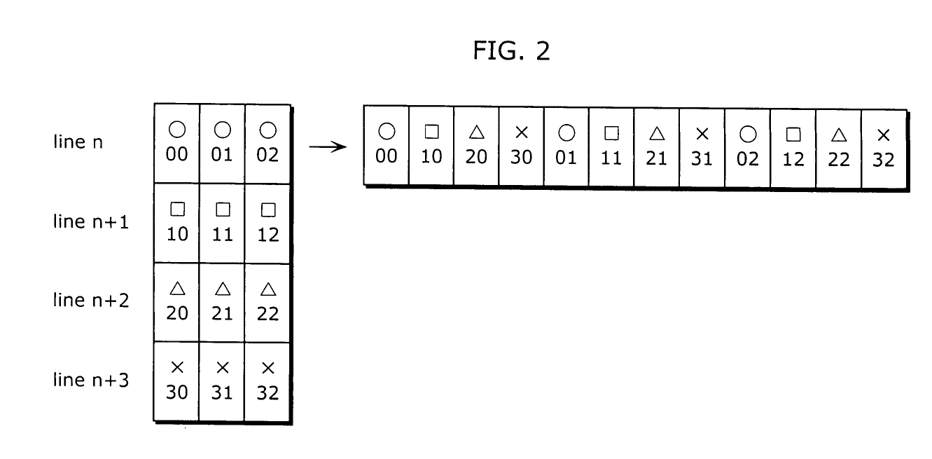

The interleaving unit 211a is a circuit which interleaves for the purpose described above, and generates either chrominance-interleaved pixel data sequence or chrominance/line-interleaved pixel data sequence according to a pre-set value (a value set in an internal register). That is to say that, in the case of chrominance interleaving, when writing a pixel block made up of blue chrominance pixels and a pixel block made up of red chrominance pixels into the DDR-DRAM 101, the interleaving unit 211a interleaves the two pixel blocks so as to generate a pixel data sequence in which the pixel data of the blue and red chrominance pixels are alternately placed in a line. In the case of chrominance/line interleaving, when writing the blue and red chrominance pixels into the DDR-DRAM 101 per p×q pixel unit made up of p lines of pixels aligned in a vertical direction and q rows of pixels aligned in a horizontal direction, the interleaving unit 211a interleaves the pixel data of the blue and red chrominance pixels as well as q rows of p×q pixels so as to generate a pixel data sequence (pixel data sequence of p×q×2 pixels) in such a manner that the pixel data of the blue chrominance pixel and the pixel data of the red chrominance pixel are alternately placed to make a line. For example, when writing the respective blue and red chrominance pixels into the DDR-DRAM 101 per macroblock made up of 9 lines×5 pixels, the interleaving unit 211a interleaves 9 lines×5 pixels per 4 lines×5 pixels so that the pixel data of the blue chrominance pixel and the pixel data of the red chrominance pixel are alternately placed to make a line, and also the pixel data of 9 lines×5 pixels is placed on one line as shown in FIG. 2, so as to generate a pixel data sequence of 9×5×2 pixels. To be more concrete, assuming that the pixel data of the blue and red chrominance pixels in line i, row j is expressed as Yb (i,j) and Yr (i,j), the interleaving unit 211a generates a pixel data sequence so that the pixel data of the blue and red chrominance pixels is placed in the order of Yb (1,1), Yr (1,1), Yb (2,1) Yr (2,1), Yb (3,1), Yr (3,1), Yb (4,1), Yr (4,1), Yb (1,2), Yr (1,2), Yb (2,2) Yr (2,2), Yb (3,2) Yr (3,2), Yb (4,2), Yr (4,2), Yb (1,3), Yr (1,3), . . . , Yb (4,5), Yr (4,5). The decoded chrominance pixel output unit 211 writes the interleaved pixel data sequence generated by the interleaving unit 211a into the DDR-DRAM 101.

The reference luminance pixel input unit 204 is a circuit which reads out the pixel data of reference luminance pixel to be used for motion estimation from the DDR-DRAM 101 via the memory control unit 102, and puts the placement of the interleaved pixel data back to the original placement, and has a de-interleaving unit 204a. The interleaving unit 204a is a circuit which performs de-interleaving for the purpose described above, and performs processing inverse to the interleaving performed by the interleaving unit 210a included in the decoded luminance pixel output unit 210, that is, processing of putting the interleaved pixel data sequence back to the original pixel data sequence. The reference luminance pixel input unit 204 stores the pixel data of reference luminance pixel which has been de-interleaved by the de-interleaving unit 204a into the motion estimation internal memory 105.

The reference chrominance pixel input unit 207 is a circuit which reads out the pixel data of reference chrominance pixel from the DDR-DRAM 101 via the memory control unit 102, and has a de-interleaving unit 207a. The de-interleaving 207a is a circuit which performs de-interleaving for the purpose described above, and performs processing inverse to the interleaving performed by the interleaving unit 211a included in the decoded chrominance pixel output unit 211, that is, a process of putting the chrominance-interleaved or chrominance/line interleaved pixel data sequence back to the original pixel data sequence. The reference chrominance pixel input unit 207 outputs the pixel data of reference chrominance pixel which has been de-interleaved by the de-interleaving unit 207a to the chrominance motion compensation coding/decoding unit 109.

Next, a characteristic operation of the image coding apparatus 200 of the present embodiment which is configured as described above will be described in detail. Here, the operation carried out by the decoded chrominance pixel output unit 211, that is, the process of chrominance interleaving or chrominance/line interleaving the pixel data of the decoded chrominance pixel outputted from the chrominance motion compensation coding/decoding unit 109, and then, storing the interleaved pixel data in the DDR-DRAM 101 will be described using a concrete example.

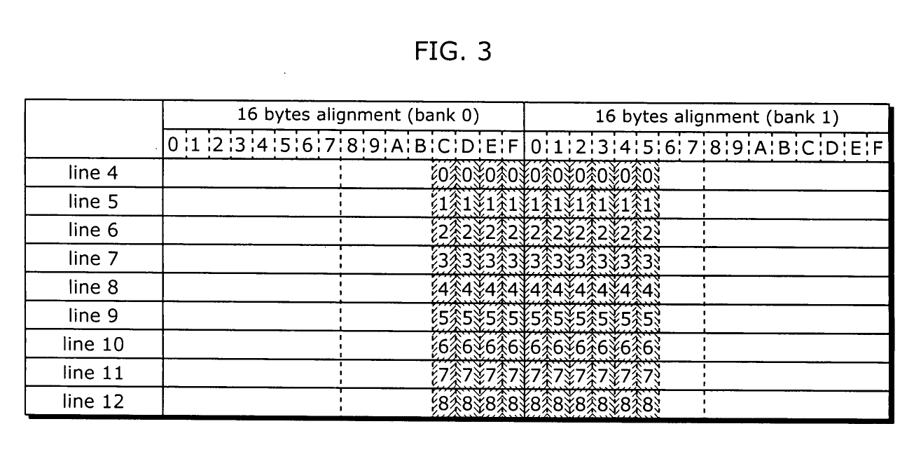

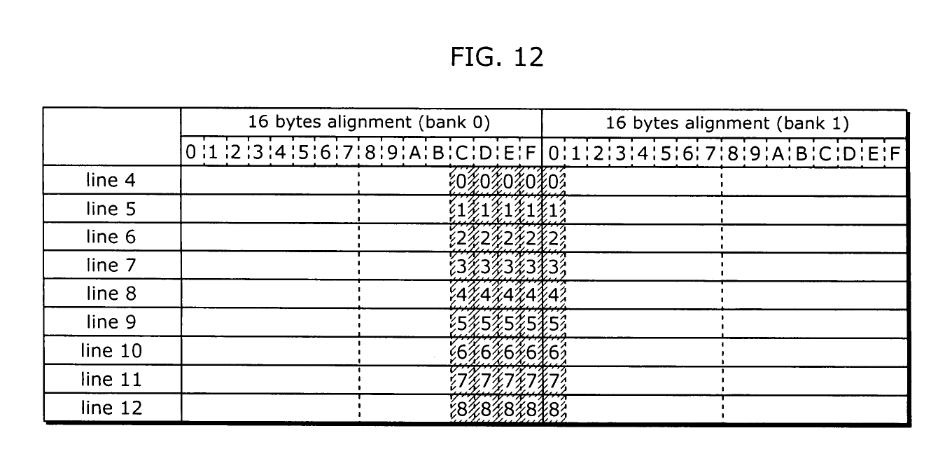

FIG. 3 is a diagram showing a memory placement for the pixel data of the chrominance pixel in the case where the decoded chrominance pixel output unit 211 chrominance interleaves the pixel data and stores the interleaved pixel data into the DDR-DRAM 101. The diagram corresponds to FIG. 12 showing the conventional technology. In other words, FIG. 3 is a memory placement diagram in the case where the number of banks that are placed across the banks becomes the greatest. In the diagram, a square hatched with lines that are diagonally right up shows the pixel data of a blue chrominance pixel while a square hatched with lines that are diagonally left up shows the pixel data of a red chrominance pixel. Here, the diagram shows that two interleaved chrominance pixel blocks of 5 pixels×9 lines are placed.

Thus, the decoded chrominance pixel output unit 211 (more precisely, the interleaving unit 211a) interleaves two types of chrominance pixels in such a manner that a blue chrominance pixel and a red chrominance pixel are alternately placed. As can be seen from the comparison between FIG. 3 and FIG. 12 which shows the conventional technology, even though the pixel data of chrominance pixel are placed across the banks in both diagrams, the difference is that only one chrominance pixel is placed in the conventional case while two chrominance pixels are placed in the present embodiment. Therefore, in the present embodiment the number of accesses decreases to half of the number of accesses, compared with the conventional case.

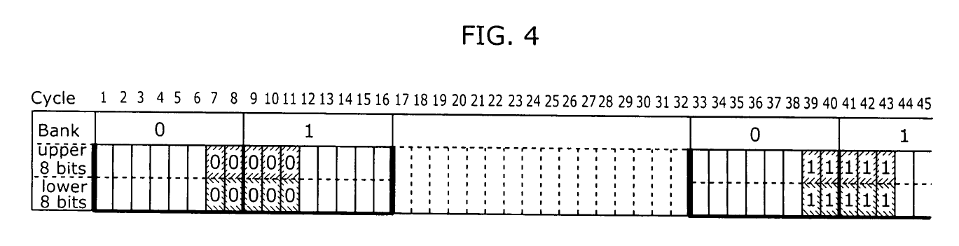

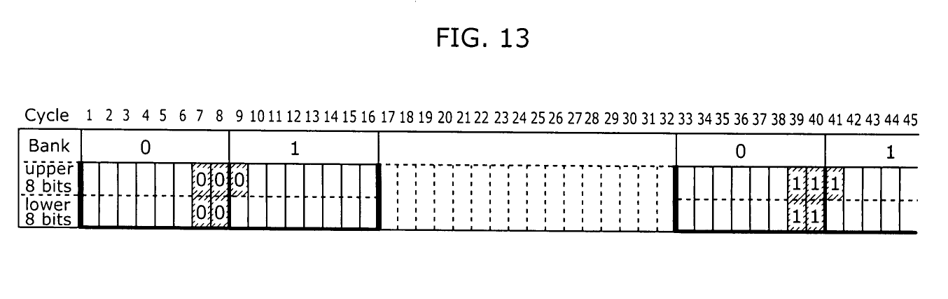

FIG. 4 is a diagram showing a timing of data transfer in the memory placement shown in FIG. 3. The diagram shows how the pixel data of two chrominance pixels of one line (5 pixels) is transferred. As can be seen from the comparison between FIG. 4 and FIG. 13 which shows the conventional technology, in either case, two banks out of four banks show actual transfer. Therefore, according to the present embodiment, although two types of chrominance pixels are interleaved, the same problem of memory access overhead occurs as in the conventional case.

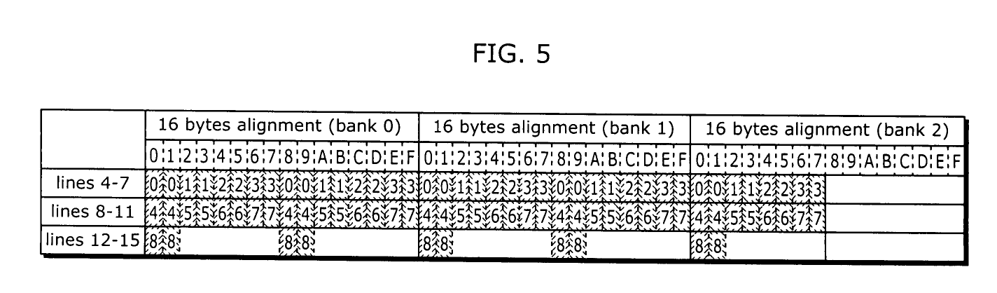

FIG. 5 is a diagram showing a memory placement for pixel data of chrominance pixels in the case where the decoded chrominance pixel output unit 211 chrominance/line interleaves the pixel data and stores the interleaved pixel data into the DDR-DRAM 101. The diagram corresponds to FIG. 12 showing the conventional technology. In other words, FIG. 5 is a memory placement diagram in the case where the number of banks which are placed across the banks becomes the greatest. Here, the diagram shows that two chrominance pixel blocks of 9 lines×5 pixels are interleaved by the type of chrominance (blue and red), and by every four lines.

Thus, the decoded chrominance pixel output unit 211 (interleaving unit 211a) interleaves two types of chrominance pixels so that a blue chrominance pixel and a red chrominance pixel are alternately placed, and also, interleaves 9 lines×5 pixels per four lines, so as to generate, for the respective chrominance pixels, a pixel data sequence as shown in FIG. 2. As can be seen from the comparison between FIG. 5 and FIG. 12, for placing two chrominance pixel blocks of five pixels×nine lines, the conventional case requires two (for blue and red chrominance pixels) of nine lines in two banks, whereas the present case only needs three lines in the consecutive three banks. Therefore, in the embodiment, the number of accesses is 16 (bytes/bank)×3 (banks)×3 (lines): 16 (bytes/bank)×2 (banks)×9 (lines)×2, that is, a fourth of the conventional number of accesses.

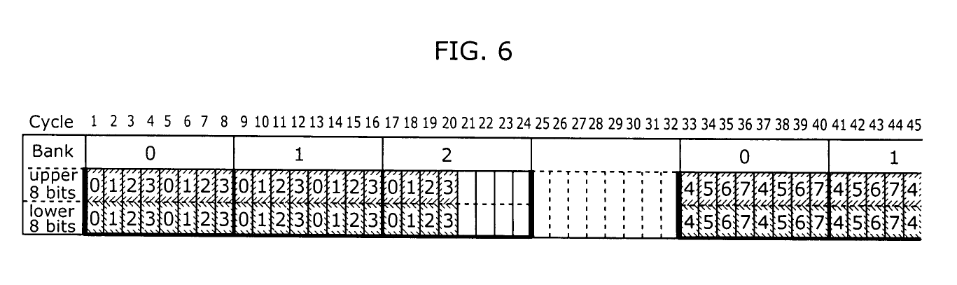

FIG. 6 is a diagram showing a timing of data transfer in the memory placement shown in FIG. 5. Here, the diagram shows how the pixel data of the first line (4-7 lines of blue and red chrominance pixels) which has chrominance/line-interleaved is transferred. As can be seen in the comparison between FIG. 6 and FIG. 13, for transferring the pixel data of one line, the pixel data of only two banks out of four banks is actually transferred in the conventional case, whereas the pixel data of two and a half banks out of four banks is actually transferred in the present case. Therefore, the number of cycles decreases in the present case compared with the conventional case.

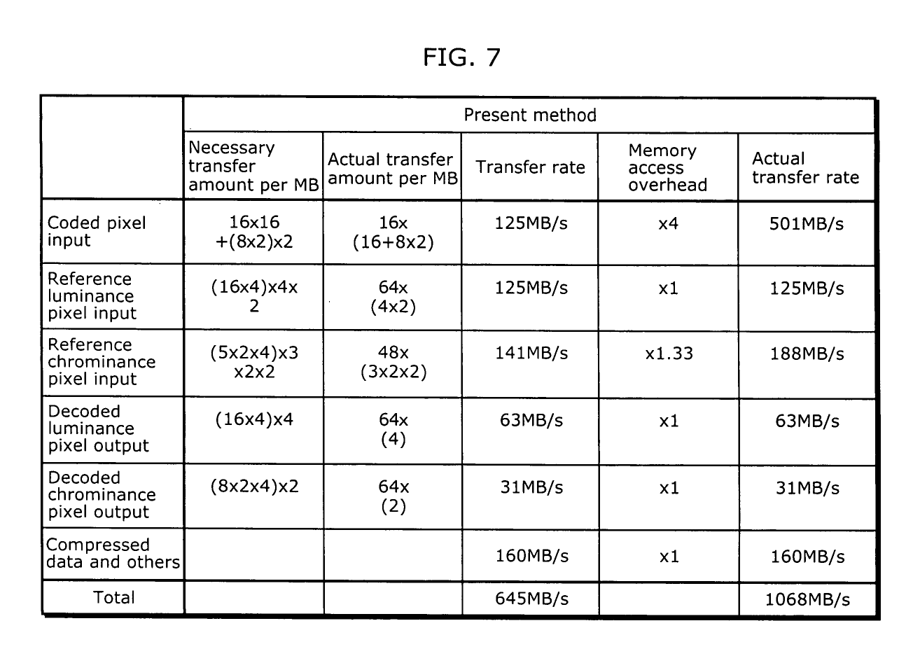

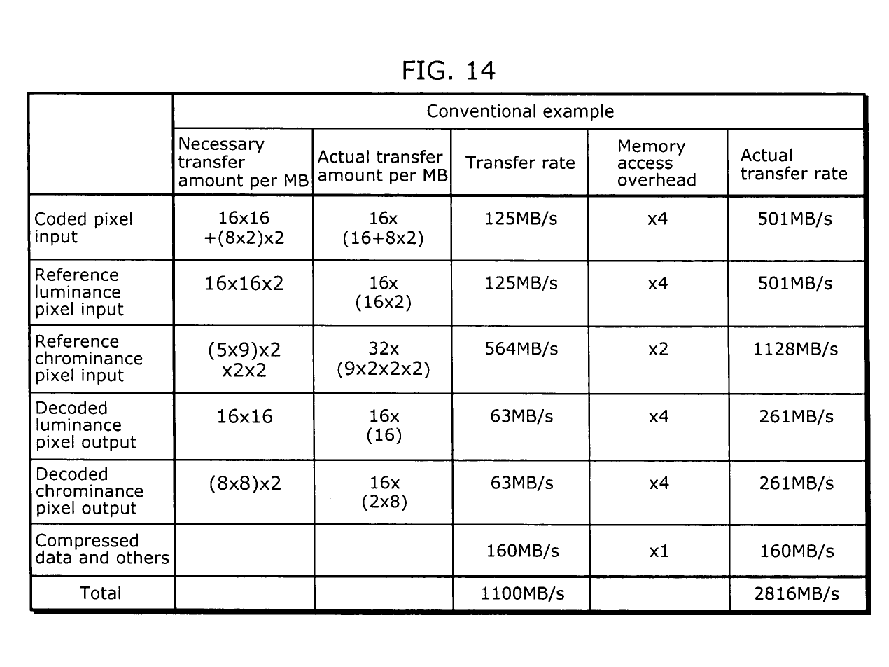

FIG. 7 is a diagram showing a concrete example of the access speed at which the image coding apparatus 200 accesses the DDR-DRAM 101, according to the embodiment in which the chrominance/line interleaving shown in FIGS. 5 and 6 is performed. The diagram corresponds to FIG. 14 showing the conventional technology. In other words, FIG. 7 shows the data transfer required between the DDR-DRAM 101 and the image coding apparatus 200 in the case where the image coding apparatus 200 codes HD video of horizontal 1920 pixels, vertical 1088 lines, 30 frames/second. In the left column, “coded pixel input”, “reference luminance pixel input”, “reference chrominance pixel input”, “decoded luminance pixel output”, “decoded chrominance pixel output”, “compressed data and others” and “total” are related to a transfer (read/write) of the pixel data between the DDR-DRAM 101 and the coded pixel input unit 103, the reference luminance pixel input unit 204, the reference chrominance pixel input unit 207, the decoded luminance pixel output unit 210, the decoded chrominance pixel output unit 211, the coded output unit 113 and the image coding apparatus 200, respectively.

As can be seen in the comparison between FIG. 7 and FIG. 14, “total” of “actual transfer rate” is 2816 MB/s in the conventional case whereas the present case requires only 1068 MB/s (approximately 38% of the conventional transfer rate). In particular, “actual transfer rate” of “reference chrominance pixel input” is 1128 MB/s in the conventional case whereas the present case requires only 188 MB/s (approximately 17% of the conventional transfer rate).

The followings are significations of respective values in the row “reference chrominance pixel input” in FIG. 14. That is to say that “necessary transfer amount per MB (macroblock)” is 5 (the number of horizontal pixels)×2 (two chrominance of blue and red)×4 (the number of lines to be interleaved)×3 (the number of lines after interleaving is performed)×2 (the number of data per chrominance)×2 (two for forward reference and backward reference), while “actual transfer amount per MB” is 48 (the number of bytes for three banks)×3 (the number of lines after interleaving is performed)×2 (two chrominance of blue and red)×2 (the number of data per chrominance)×2 (two for forward reference and backward reference). When the “actual transfer amount per MB” is converted into transfer rate of the HD video, “transfer rate” is 141 MB/s. The “memory access overhead” is “x1.33” due to the condition (three banks per four banks) shown in FIG. 6. Consequently, “actual transfer rate” is 188 MB/s resulting from 141 MB/s (transfer rate)×1.33 (memory access overhead).

Thus, with the image coding apparatus of the present embodiment, the pixel data is interleaved and then placed in the DDR-DRAM, which greatly reduces a transfer rate between the image coding apparatus and the DDR-DRAM. Particularly in the case where the pixel data of chrominance pixel is stored in the DDR-DRAM, the transfer rate for the input of the reference chrominance pixel decreases to 17% of the conventional transfer rate, while a total transfer rate decreases to 38% of the conventional total transfer rate. Thus, it is possible to lower the cost by the application of a DDR-DRAM with a low access speed, and to enable low power consumption through reduction in the speed of clock rate.

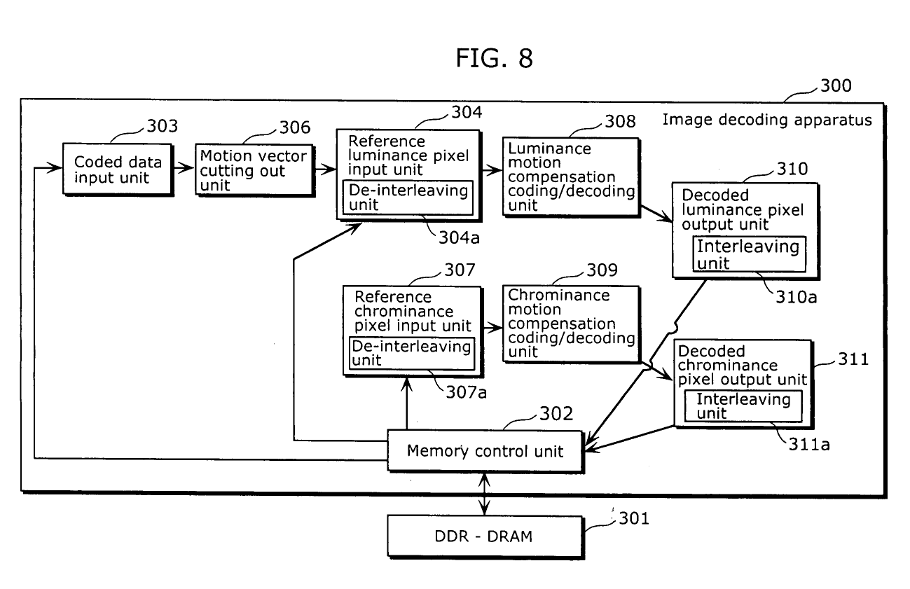

FIG. 8 is a functional block diagram showing the configuration of an image decoding apparatus 300 of the present embodiment. Note that a DDR-DRAM 301 in the diagram is a DRAM that is externally attached to the image decoding apparatus 300. The image decoding apparatus 300 corresponds to the image coding apparatus 200 shown in FIG. 1 and is equipped with a function to interleave the pixel data of the decoded luminance pixel and decoded chrominance pixel, and to store the interleaved pixel data into the DDR-DRAM 301. The image decoding apparatus 300 is configured of a memory control unit 302, a coded data input unit 303, a reference luminance pixel input unit 304, a motion vector cutting out unit 306, a reference chrominance pixel input unit 307, a luminance decoding/motion compensation unit 308, a chrominance decoding/motion compensation unit 309, a decoded luminance pixel output unit 310 and a decoded chrominance pixel output unit 311.

The memory control unit 302 is a circuit which controls input and output of the data between the DDR-DRAM 301 and the image decoding apparatus 300. The coded data input unit 303 is a circuit which reads out the coded data to be decoded from the DDR-DRAM 301. The motion vector cutting out unit 306 is a circuit which cuts out the motion vector from the coded data read-out by the coded data input unit 303. The reference luminance pixel input unit 304 is a circuit which reads out the pixel data of reference luminance pixel from the DDR-DRAM 301. The reference chrominance pixel input unit 307 is a circuit which reads out the pixel data of reference chrominance pixel from the DDR-DRAM 301. The luminance decoding/motion compensation unit 308 is a circuit which performs decoding and motion compensation on luminance pixels. The chrominance decoding/motion compensation unit 309 is a circuit which performs decoding and motion compensation on chrominance pixels. The decoded luminance pixel output unit 310 is a circuit which outputs the pixel data of the decoded luminance pixel to the DDR-DRAM 301. The decoded chrominance pixel output unit 311 is a circuit which outputs the pixel data of the decoded chrominance pixel to the DDR-DRAM 301.

The decoded luminance pixel output unit 310 is a circuit which interleaves the pixels of plural lines out of the decoded luminance pixels obtained by the luminance decoding/motion compensation unit 308, and stores the interleaved pixel data into the DDR-DRAM 301 via the memory control unit 302, and has an interleaving unit 310a. The interleaving unit 310a has the same function as the interleaving unit 210a shown in FIG. 1.

The decoded luminance pixel output unit 311 chrominance interleaves or chrominance/line interleaves the pixel data of the decoded chrominance pixels obtained by the chrominance decoding/motion compensation unit 309, and stores the interleaved pixel data into the DDR-DRAM 301 via the memory control unit 302, and has an interleaving unit 311a. The interleaving unit 311a has the same function as the interleaving unit 211a shown in FIG. 1.

The reference luminance pixel input unit 304 is a circuit which reads out the pixel data of the reference luminance pixel to be used for motion compensation from the DDR-DRAM 301 via the memory control unit 302, and puts the placement of the interleaved pixel data back to the original placement (de-interleaving), and has a de-interleaving unit 304a. The de-interleaving unit 304a has the same function as the de-interleaving unit 204a shown in FIG. 1.

The reference chrominance pixel input unit 307 is a circuit which reads out the pixel data of the reference chrominance pixel from the DDR-DRAM 301 via the memory control unit 302, and has a de-interleaving unit 307a. The de-interleaving unit 307a has the same function as the de-interleaving unit 207a shown in FIG. 1.

Even with the image decoding apparatus 300 of the embodiment, configured of the components as described above, the pixel data of reference luminance pixel and reference chrominance pixel is interleaved and then stored in the DDR-DRAM 301, as is the case of the image coding apparatus 200, the respective transfer rates of the pixel data exchanged between the DDR-DRAM 301 and the reference luminance pixel input unit 304, the reference chrominance pixel input unit 307, the decoded luminance pixel output unit 310, and the decoded chrominance pixel output unit 311 greatly decrease compared with the conventional technology which does not perform interleaving.

As described above, the image processor of the present invention is described based on the embodiment; however, the present invention is not limited to this embodiment.

For example, the present embodiment shows an example in which the present invention is applied to an image coding apparatus and an image decoding apparatus. The image processor of the present invention, however, can be applied not only to such image coding apparatus and decoding apparatus, but also to any sorts of image processor externally equipped with a memory such as a DDR-DRAM that stores image data.

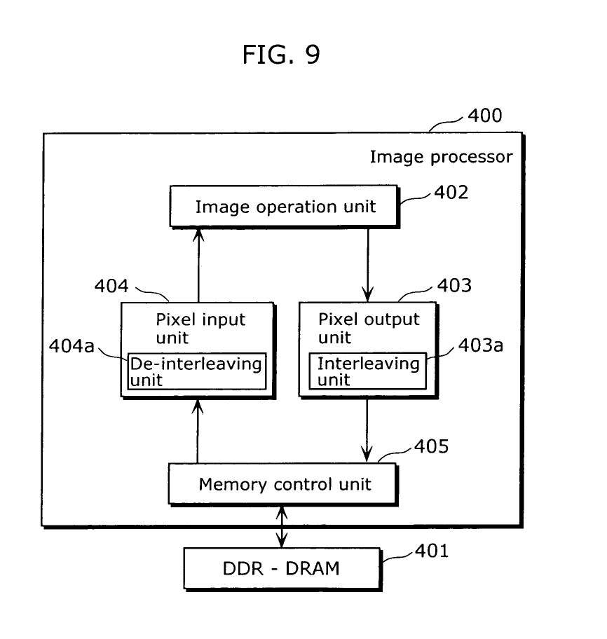

FIG. 9 is a block diagram showing an image processor 400 in the case of applying the present invention to a general image processor. The image processor 400, connected to a DDR-DRAM 401, performs image processing on the pictures held in the DDR-DRAM 401, and is configured of an image operation unit 402, a pixel output unit 403, a pixel input unit 404 and a memory control unit 405.

The image operation unit 402 is a processor, or the like, which performs image processing such as smoothing, outline extraction, motion estimation, compression, expansion. The memory control unit 405 is a circuit which controls input and output of the data between the DDR-DRAM 401 and the image processor 400.

The pixel output unit 403 is a processing unit which writes pixel data into the DDR-DRAM 401 via the memory control unit 405 per p×q pixel unit or per p×q pixel units, each pixel unit being made up of p (p is a natural number of 2 or greater) lines of pixels aligned in a vertical direction and q (q is a natural number) rows of pixels aligned in a horizontal direction. Such a pixel output unit 403 has an interleaving unit 403a which interleaves q rows p×q pixels to be written in the DDR-DRAM 401 so as to generate a pixel data sequence in which the pixel data of the pixels located in q rows is multiplexed and placed on one line. Alternatively, the interleaving unit 403a executes one of the followings according to a pre-set parameter: interleaving only lines; interleaving only chrominance; and interleaving both chrominance and lines.

The pixel input unit 404 is a processing unit which reads out pixel data from the DDR-DRAM 401 via the memory control unit 405 per p×q pixel unit or p×q pixel units, and has a de-interleaving unit 404a. The de-interleaving unit 404a performs processing inverse to the interleaving performed by the interleaving unit 403a, that is, processing of putting the interleaved pixel data sequence read-out from the DDR-DRAM 401 back to the original pixel data sequence.

Even with such a versatile image processor, the pixel data of luminance pixel or chrominance pixel is interleaved and then stored in the DDR-DRAM 401, as is the case of the image coding apparatus 200 and the image decoding apparatus 300. Therefore, transfer rates for transmitting pixel data between the DDR-DRAM 401, and each of the pixel output unit 403 and the pixel input unit 404 greatly decrease compared with the conventional technology which does not perform interleaving.

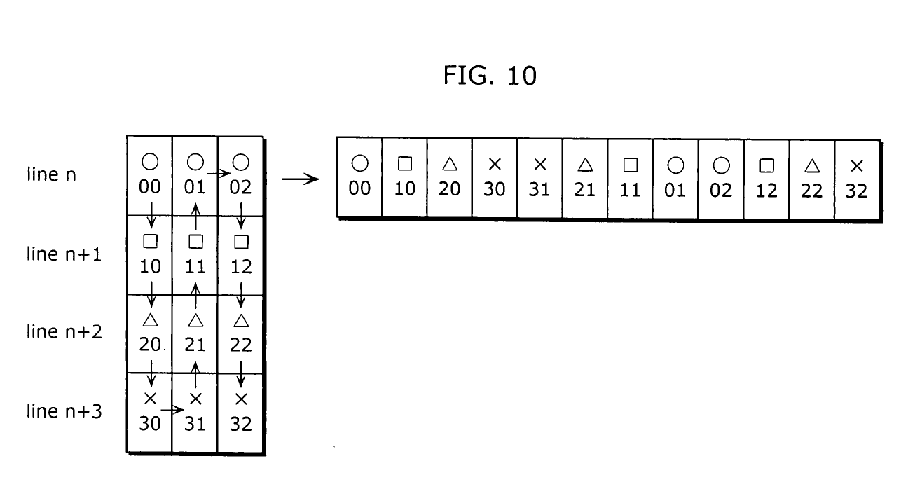

In the present embodiment, in the case of interleaving lines, a pixel data sequence, in which the sequence of the pixel data of each row is repeatedly placed in the same order (from the first line to the pth line), is generated; however, the method of line interleaving according to the present invention is not limited to such a sequence. For example, as a method of interleaving four lines, a pixel data sequence may be generated in such a way that the sequence of the pixel data of rows is interchanged (the first line to the pth line, the pth line to the first line, the first line to the pth line, . . . ), as shown in FIG. 10.

In the present embodiment, the decoded chrominance pixel output unit 211 of the image coding apparatus 200 executes one of chrominance interleaving and chrominance/line interleaving; however, the interleaving method is not limited to them. The decoded chrominance pixel output unit 211, like the decoded luminance pixel output unit 210, may interleave only lines. In such a case, the interleaving unit 210a of the decoded luminance pixel output unit 210 and the interleaving unit 211a of the decoded chrominance pixel output unit 211 are to perform interleaving based on the same method so that the interleaving can be realized using a common circuit or program.

Also, the present embodiment shows an example of line interleaving four lines; however, the present invention is not limited to this. Line interleaving two lines, eight lines, sixteen lines or the like is possible. In this case, it is preferable that the number of lines to be interleaved is a value of power-of-two. In this case, the interleaved pixel data sequence equals to the access alignment (e.g. 16 bytes alignment) of the DDR-DRAM, or is integral multiple or parts of integral number. This heightens the possibility at which the pixel data sequence is effectively stored in the banks of the DDR-DRAM, and may decrease the data transfer rate.

In the present embodiment, a pixel data sequence of one line is generated as a result of interleaving one by one the pixel data of different types (chrominance or line is different). The present invention, however, is not limited to such a unit of interleaving, and two or more pixel data may be interleaved as a unit. For example, interleaving may be performed so that the pixel data of the second line, second row may be placed on one line after the pixel data of two rows of the first line or the whole pixel data of the second line are placed in a line after the whole pixel data of the first line which constitutes a current block to be processed. This is because it is possible to enhance data transfer efficiency between an image processor and a memory by putting together the pixel data of plural lines into pixel data sequence of one line.

Although only one exemplary embodiment of this invention has been described in detail above, those skilled in the art will readily appreciate that many modifications are possible in the exemplary embodiment without materially departing from the novel teachings and advantages of this invention. Accordingly, all such modifications are intended to be included within the scope of this invention.

### INDUSTRIAL APPLICABILITY

The present invention can be used as an image processor or the like which performs image processing on the pictures held in a memory, for example, an image coding apparatus which performs compression/coding on video and an image decoding apparatus which performs expansion/decoding of compressed video, and especially as an image processing LSI to be used in a video apparatus which processes images with high resolution such as HD video or the like.

What is claimed is:

1. An image processor which is connected to a memory and performs image processing on a picture held in the memory, said processor comprising:
a pixel output unit operable to write pixel data of pixels into the memory per p×q pixel unit or p×q pixel units, where p is a natural number of 2 or greater and q is a natural number, the pixel unit being made up of p lines of pixels aligned in a vertical direction and q rows of pixels aligned in a horizontal direction;
a pixel input unit operable to read the pixel data per p×q pixel unit or p×q pixel units from the memory; and
an interleaving unit operable to interleave q rows of p×q pixels to be written into the memory, so as to generate a pixel data sequence in which the pixel data of the pixels located in q rows are multiplexed and placed on one line.

2. The image processor according to claim 1, further comprising:
a coding unit operable to estimate a motion of an image of the picture by referring to the pixel data read by said pixel input unit, and to code the picture using the estimated motion; and
a decoding unit operable to decode the coded picture,
wherein said pixel output unit is operable to write, into the memory, the pixel data of the picture decoded by said decoding unit, and
said pixel input unit is operable to read, from the memory, the pixel data written by said pixel output unit.

3. The image processor according to claim 1, further comprising
a decoding unit operable to obtain the coded picture and decode the obtained picture with reference to the pixel data read by said pixel input unit,
wherein said pixel output unit is operable to write, into the memory, the pixel data of the picture decoded by said decoding unit, and
said pixel input unit is operable to read, from the memory, the pixel data written by said pixel output unit.

4. The image processor according to claim 1,
wherein the picture includes first and second chrominance images, and
said interleaving unit is operable to interleave q rows of p×q pixels of the first and second chrominance images and the pixel data of the first and second chrominance images so as to generate a pixel data sequence in which the pixel data of the first chrominance image and the pixel data of the second chrominance image are alternately placed to make a line and the pixel data of the respective chrominance images of the pixels located in q rows are multiplexed and placed on one line.

5. The image processor according to claim 4, further comprising
a coding unit operable to estimate a motion of an image of the picture, and to code the picture using the estimated motion; and
a decoding unit operable to decode the coded picture,
wherein said pixel output unit is operable to write, into the memory, the pixel data of the first and second chrominance images decoded by said decoding unit,
said pixel input unit is operable to read, from the memory, the pixel data written by said pixel output unit, and
said coding unit is operable to code the picture with reference to the pixel data read by said pixel input unit.

6. The image processor according to claim 4, further comprising
a decoding unit operable to obtain a coded picture and decode the obtained picture with reference to the pixel data read by said pixel input unit,
wherein said pixel output unit is operable to write, into the memory, the pixel data of the first and second chrominance images decoded by said decoding unit, and
said pixel input unit is operable to read the pixel data written by said pixel output unit from the memory.

7. The image processor according to claim 1,
wherein p is a value of power-of-two.

8. An image processor which is connected to a memory and performs image processing on a picture having a first chrominance image and a second chrominance image held in the memory, said processor comprising:
a pixel output unit operable to write pixel data of pixels into the memory per p×q pixel unit or p×q pixel units, where p is a natural number of 2 or greater and q is a natural number, the pixel unit being made up of p lines of pixels aligned in a vertical direction and q rows of pixels aligned in a horizontal direction;
a pixel input unit operable to read the pixel data from the memory per p×q pixel unit or p×q pixel units; and
an interleaving unit operable to interleave the pixel data of p×q pixels of the first and second chrominance images to be written in the memory, so as to generate a pixel data sequence in which the pixel data of the first chrominance image and the pixel data of the second chrominance image are alternately placed to make a line.

9. The image processor according to claim 8, further comprising:
a coding unit operable to estimate a motion of an image of the picture and code the picture using the estimated motion; and
a decoding unit operable to decode the coded picture,
wherein said pixel output unit is operable to write, into the memory, the pixel data of the first and second chrominance images decoded by said decoding unit,
said pixel input unit is operable to read the pixel data written by said pixel output unit from the memory, and
said coding unit is operable to code the picture with reference to the pixel data read by said pixel input unit.

10. The image processor according to claim 8, further comprising
a decoding unit operable to obtain the coded picture and decode the obtained picture with reference to the pixel data read by said pixel input unit,
wherein said pixel output unit is operable to write, into the memory, the pixel data of the first and second chrominance images decoded by said decoding unit, and
said pixel input unit is operable to read the pixel data written by said pixel output unit from the memory.

11. An image processing method for performing image processing on a picture held in a memory, said method comprising:
writing pixel data of pixels into the memory per p×q pixel unit or p×q pixel units, where p is a natural number of 2 or greater and q is a natural number, the pixel unit being made up of p lines of pixels aligned in a vertical direction and q rows of pixels aligned in a horizontal direction; and
reading the pixel data from the memory per p×q pixel unit or p×q pixel units,
wherein said writing includes interleaving q rows of p×q pixels to be written into the memory so as to generate a pixel data sequence in which the pixel data of the pixels located in q rows are multiplexed and placed on one line.

12. The image processing method according to claim 11,
wherein the picture includes first and second chrominance images, and
in said interleaving, q rows of p×q pixels of the first and second chrominance images are interleaved so that a pixel data sequence is generated, the pixel data sequence being a sequence in which the pixel data of the first chrominance image and the pixel data of the second chrominance image are alternately placed to make a line and the pixel data of the respective chrominance images of the pixels located in q rows are multiplexed and placed on one line.

13. An image processing method for performing image processing on a picture held in a memory, said method comprising:
writing pixel data of pixels into the memory per p×q pixel unit or p×q pixel units, where p is a natural number of 2 or greater and q is a natural number, the pixel unit being made up of p lines of pixels aligned in a vertical direction and q rows of pixels aligned in a horizontal direction; and
reading the pixel data from the memory per p×q pixel unit or p×q pixel units,
wherein said writing includes interleaving q rows of p×q pixels of the first and second chrominance images to be written into the memory, so as to generate a pixel data sequence in which the pixel data of the first chrominance image and the pixel data of the second chrominance image are alternately placed to make a line.

14. A computer readable medium having a program for performing image processing on a picture held in a memory, said program, when executed by a computer performs the steps of:
writing pixel data of pixels into the memory per p×q pixel unit or p×q pixel units, where p is a natural number of 2 or greater and q is a natural number, the pixel unit being made up of p lines of pixels aligned in a vertical direction and q rows of pixels aligned in a horizontal direction; and
reading the pixel data from the memory per p×q pixel unit or p×q pixel units,
wherein said writing includes interleaving q rows of p×q pixels to be written into the memory, so as to generate a pixel data sequence in which the pixel data of the pixels located in q rows are multiplexed and placed on one line.

15. A computer readable medium having a program for performing image processing on a picture held in a memory, said program, when executed by a computer performs the steps of:
writing pixel data of pixels into the memory per p×q pixel unit or p×q pixel units, where p is a natural number of 2 or greater and q is a natural number, the pixel unit being made up of p lines of pixels aligned in a vertical direction and q rows of pixels aligned in a horizontal direction; and
reading the pixel data from the memory per p×q pixel unit or p×q pixel units,
wherein said writing includes interleaving q rows of p×q pixels of the first and second chrominance images to be written into the memory, so as to generate a pixel data sequence in which the pixel data of the first chrominance image and the pixel data of the second chrominance image are alternately placed to make a line.
